(19) United States
(12) Patent Application Publication
(10) Pub. No.: US 2025/0050629 A1
(43) Pub. Date: Feb. 13, 2025

(54) PAPER LAMINATE PLASTIC VIAL

(71) Applicant: Pouch Pac Innovations, LLC, Sarasota, FL (US)

(72) Inventor: R. Charles Murray, Sarasota, FL (US)

(21) Appl. No.: 18/930,417

(22) Filed: Oct. 29, 2024

Related U.S. Application Data
(63) Continuation of application No. 18/082,821, filed on Dec. 16, 2022, now Pat. No. 12,128,659.
(60) Provisional application No. 63/290,162, filed on Dec. 16, 2021.

(51) Int. Cl. B32B 29/00; B32B 15/12; B32B 15/20; B32B 27/10; B32B 27/30

(52) U.S. Cl. CPC B32B 29/002; B32B 15/12; B32B 15/20; B32B 27/10; B32B 27/306; B32B 2250/03; B32B 2307/732; B32B 2439/40

(57) ABSTRACT

A laminate container (e.g., a vial) is disclosed. The laminate container includes a body having a cavity and a peripheral portion that defines a seal. The body includes laminate sheet including an outer paper layer, a middle barrier layer joined with the outer layer, and an inner layer formed of a plastic material joined with the middle barrier layer. According to an example, the middle barrier layer is formed of aluminum.

### CROSS-REFERENCE

This application is a continuation application of U.S. patent application Ser. No. 18/082,821 filed on Dec. 16, 2022, now issued as U.S. Pat. No. 12,128,659, which claims priority to U.S. Prov. App. No. 63/290, 162 filed on Dec. 16, 2021, the contents of each of which are hereby incorporated by reference in their entirety.

### FIELD OF THE INVENTION

The invention relates to plastic vials and more particularly to an opening mechanism for vials molded from plastic sheets.

### BACKGROUND OF THE INVENTION

It is known to form plastic vials from two overlaid sheets of plastic material. The vial has a profile of the little shape molded into the center with a peripheral planar portion extending around the profile. The profile generally has a bottom cylindrical portion with an upper spout portion which is used to dispense the contents in the spout.

Due to concerns about the recycling of such vials, it would be desirable to have vials made of recycled materials or of materials that may be easily recycled.

### SUMMARY OF THE INVENTION

In one aspect, there is disclosed a laminate vial including a first laminate sheet including an outer paper layer and a middle barrier layer joined with the outer layer, the middle barrier layer joined with an inner layer formed of a plastic material. Also included is a second laminate sheet including an outer paper layer and a middle barrier layer joined with the outer layer, the middle barrier layer joined with an inner layer formed of a plastic material. The first laminate sheet is joined to the second laminate sheet to define a seal and a cavity.

In another aspect, there is disclosed a laminate vial including a first laminate sheet including an outer paper layer and a middle barrier layer of aluminum joined with the outer layer, the middle barrier layer joined with an inner layer formed of EVOH/LLDPE. Also included is a second laminate sheet an outer paper layer and a middle barrier layer of aluminum joined with the outer layer, the middle barrier layer joined with an inner layer formed of EVOH/LLDPE. The first laminate sheet is joined to the second laminate sheet to define a seal and a cavity.

In a further aspect, there is disclosed a laminate vial including a first laminate sheet including an outer recycled paper layer and a middle barrier layer of recycled aluminum joined with the outer layer, the middle barrier layer joined with an inner layer formed of recycled EVOH/LLDPE. Also included is a second laminate sheet an outer recycled paper layer and a middle barrier layer of recycled aluminum joined with the outer layer, the middle barrier layer joined with an inner layer formed of recycled EVOH/LLDPE. The first laminate sheet is joined to the second laminate sheet to define a seal and a cavity.

### BRIEF DESCRIPTION OF THE DRAWINGS

FIG. 1 is a perspective view of a flexible vial pouch according to an embodiment of the present invention;

FIG. 2 is a side view of the embodiment shown in FIG. 1;

FIG. 3 is a partial sectional view showing a laminate structure;

FIG. 4 is a perspective view of a flexible vial pouch according to an embodiment of the present invention;

FIG. 5 is a perspective view of a flexible vial pouch according to an embodiment of the present invention;

FIG. 6 is a perspective view of a flexible vial pouch according to an embodiment of the present invention.

### DETAILED DESCRIPTION OF THE PREFERRED EMBODIMENTS

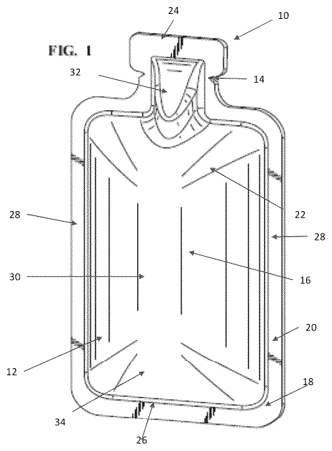

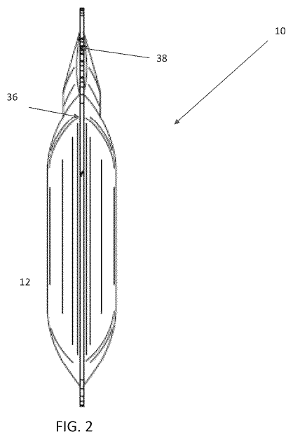

A novel vial 10 for containing squeezable, highly viscous, or semisolid material is shown in FIGS. 1-2. The vial 10 has a cavity 12 to hold materials such as lotions or gels or other viscous products. The vial 10 has a notch or opening 14 to permit the vial to open to dispense the contents 16. The vial 10 has a body 18 including a front side which has a peripheral planar portion 20 extending around a central shaped raised portion 22. The raised portion defines the cavity 12 for holding the contents of the vial and the peripheral portion 20 defines a seal.

The body has a top 24, bottom 26 and a pair of sides 28. The raised portion 22 extends outwardly in both directions from the planar portion 20 to form a cylindrical portion 30 and a spout portion 32. The cylindrical portion 30 has a bottom wall 34.

As shown in FIG. 2, the body 18 is formed by joining two laminate sheets 36, 38 at the peripheral portion 20. The two sheets may be joined by a heat seal, ultrasonic seal or other sealing operation. The notch 14 extends from one side 28 across the planar portion 20.

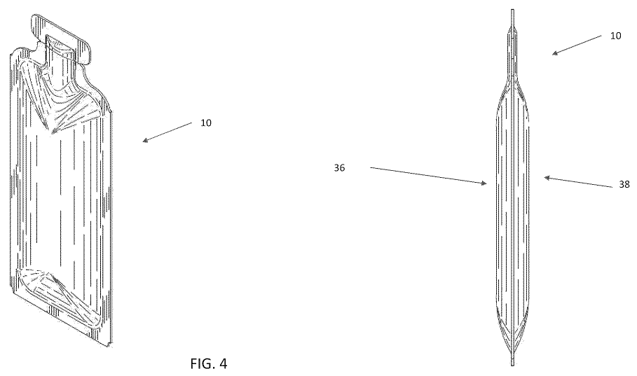

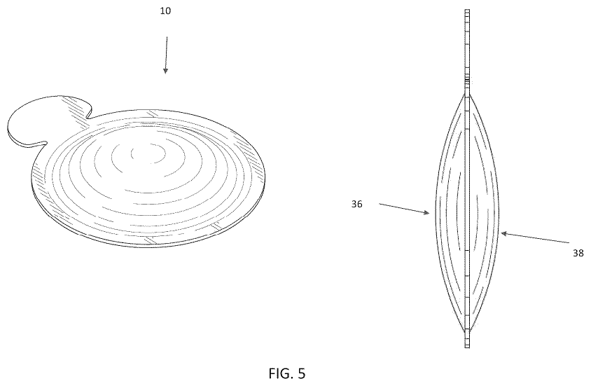

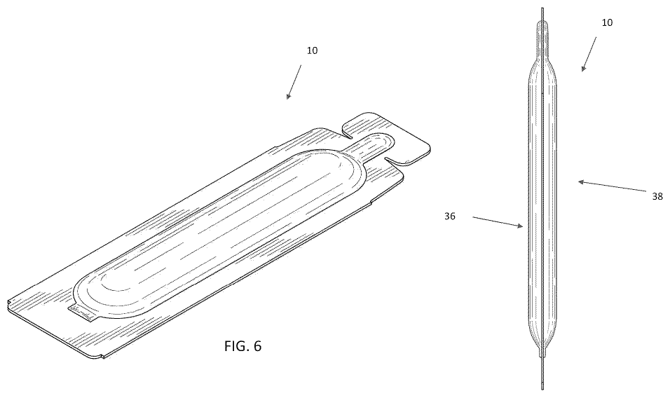

It should be realized that various shapes of vials may be used such as shown in FIGS. 4-6. The shapes include rectangular and round shapes. The vial may include a bottom gusset or other structure.

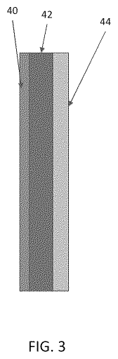

The laminate, as shown in FIG. 3, includes paper as the outermost layer 40. The paper may be a virgin paper product or a recycled paper product. In one aspect, the paper may have a thickness of from 90 to 110 μm. The paper may be printable such that a brand logo or other indicia may be included on the outer layer 40. When the outer layer 40 is formed of recycled paper, the recycled paper is subjected to an embossing operation to increase the strength characteristics of the outer layer 40. In one aspect, the recycled paper may be embossed using embossment rollers that impart fines lines to the paper. In one aspect the embossment lines may be spaced from each other in an amount of 0.5 mm or less. Such a spacing provides a desired strength to the outer layer 40.

The laminate includes a middle layer 42. The middle layer may serve as a barrier layer preventing egress of air or materials into the vial 10. The middle layer may also serve as a structural layer providing strength to the vial 10. Various materials may be utilized as a middle layer material. Included middle layer materials include: aluminum foil, ethylene vinyl alcohol copolymer (EVOH), polyester, and polyethylene terephalate (PET) and polypropylene (PP). Additionally Silicon dioxide (SiO2) and Titanium dioxide TiO2 may be utilized in both virgin and recycled form. Various combinations of the listed materials may be utilized as the middle layer 42. In one aspect, the middle may have a thickness of from 180 to 280 μm. In another aspect, the middle layer may be formed from recycled aluminum and recycled plastic materials. The recycled content may be from 50% to 100% recycled materials.

The laminate includes an inner layer 44. The inner layer may include various materials such as ethylene vinyl alcohol copolymer (EVOH) and polyethylene (PE). A particularly useful PE includes linear low density polyethylene (LLDPE) used as a sealant. In one aspect, the inner layer may have a thickness of from 40 to 60 μm. In another aspect, the inner layer may be formed from recycled plastic materials. The recycled content may be from 50% to 100% recycled materials.

Various examples of laminate structures are provided in the table below:

| Outer layer | Middle layer | Inner layer |
|---|---|---|
| Virgin paper (100 μm) | PET (250 μm) | EVOH/LLDPE (50 μm) |
| Recycled paper (100 μm) | PET (250 μm) | EVOH/LLDPE (50 μm) |
| Recycled paper (100 μm) | Al (200 μm) | EVOH/LLDPE (50 μm) |
| Virgin paper (100 μm) | Al (200 μm) | EVOH/LLDPE (50 μm) |
| Recycled paper (100 μm) | Recycled Al (200 | EVOH/LLDPE (50 μm) |
| | μm) | |
| Recycled paper (100 μm) | Recycled Al (200 | Recycled EVOH/ |
| | μm) | LLDPE (50 μm) |
| Recycled paper (110 μm) | Recycled Al (180 | Recycled EVOH/ |
| | μm) | LLDPE (40 μm) |
| Recycled paper (90 μm) | SiO2 (280 μm) | Recycled EVOH/ |
| | | LLDPE (60 μm) |
| Recycled paper (100 μm) | SiO2 (200 μm) | EVOH/LLDPE (50 μm) |
| Recycled paper (100 μm) | TiO2 (200 μm) | EVOH/LLDPE (50 μm) |

It should be realized that various thickness and types of paper, thickness and types of barrier layers and thickness and type of inner layers as described above may be utilized. In one aspect, the laminate may include sealants applied to the various layers to bond the layers together. Sealants that may be utilized include laminate film sheet adhesives that melt at around 150 degrees C.

The laminate results in a relatively soft sheet material. The sheets are flexible and thin. However when the cavity is filled and sealed, the air in the spout is compressed to make the raised profile rigid. Thus, it is possible to grasp on the top 24 of the vial to open the vial at the notch 14 across the spout 32. Once opened, the raised profile 22 becomes flexible allowing the user to easily control dispensing of the contents 16 with pressure on the cylindrical portion 30 to force the contents 16 out of the spout 32 in a desired quantity.

The novel vial provides for a completely or partially recycled material content to meet the demands of sustainable materials to reduce waste burdens and maintains a desired material within the vial. The vial has use especially in single use applications such as individual portions of soap, shampoo, condiments and other common single dose packages. The novel vial does not leak and maintains the desired product in the vial.

1.-20. (canceled)

21. A laminate container comprising:
a body having a cavity and a peripheral portion that defines a seal;
the body including a laminate sheet including an outer paper layer, a middle barrier layer joined with the outer layer, and an inner layer formed of a plastic material joined with the middle barrier layer;
wherein the middle barrier layer comprises recycled aluminum.

22. The laminate container of claim 21, wherein the paper is recycled paper.

23. The laminate container of claim 22 wherein the recycled paper is embossed forming embossment lines.

24. The laminate container of claim 23 wherein the embossment lines are spaced in an amount of 0.5 mm or less.

25. The laminate container of claim 21 wherein the plastic material of the inner layer includes ethylene vinyl alcohol copolymer (EVOH) and/or polyethylene (PE).

26. The laminate container of claim 21 wherein at least one of:
the outer paper layer has a thickness of from 90 to 110 μm;
the middle barrier layer has a thickness of from 180 to 280 μm; and
the inner layer has a thickness of from 40 to 60 μm.

27. The laminate container of claim 21 wherein the recycled aluminum of the middle barrier layer is in the form of a foil.

28. The laminate container of claim 21, which is a vial.

29. The laminate container of claim 21 wherein the body has a bottom and a top with a spout having a notch.

30. The laminate container of claim 21, wherein the body includes a second laminate sheet including an outer paper layer, a middle barrier layer joined with the outer layer, and an inner layer formed of a plastic material joined with the middle barrier layer, the laminate sheet and the second laminate sheet being joined at the peripheral portion.

31. A laminate container comprising:
a body having a cavity and a peripheral portion that defines a seal;
the body including a laminate sheet including an outer paper layer, a middle barrier layer joined with the outer layer, and an inner layer formed of a plastic material joined with the middle barrier layer;
wherein the outer paper layer includes a plurality of embossment lines; and
wherein adjacent embossment lines of the plurality of embossment lines are disposed spaced apart from one another by 0.5 mm or less.

32. The laminate container of claim 31 wherein the paper is recycled paper.

33. The laminate container of claim 31 wherein the inner layer is formed of EVOH and/or linear low density polyethylene (LLDPE).

34. The laminate container of claim 31 wherein the middle barrier layer is formed of recycled aluminum.

35. The laminate container of claim 31 wherein the outer paper layer has a thickness of from 90 to 110 μm.

36. The laminate container of claim 31 wherein the middle barrier layer has a thickness of from 180 to 280 μm.

37. The laminate container of claim 31 wherein the inner layer has a thickness of from 40 to 60 μm.

38. The laminate container of claim 31, in the form of a vial.

39. The laminate container of claim 31, wherein the body includes a second laminate sheet including an outer paper layer, a middle barrier layer joined with the outer layer, and an inner layer formed of a plastic material joined with the middle barrier layer, the laminate sheet and the second laminate sheet being joined at the peripheral portion.

40. The laminate container of claim 31, wherein the middle barrier layer comprises silicon dioxide (SiO₂) or titanium dioxide (TiO₂).
